(19) United States
(12) Patent Application Publication
(10) Pub. No.: US 2008/0009307 A1
(43) Pub. Date: Jan. 10, 2008

(54) System and method for optimized wireless client communication

(76) Inventors: Ramesh Sekhar, San Jose, CA (US); Robert Beach, Los Altos, CA (US)

Correspondence Address: FAY KAPLUN & MARCIN, LLP, 15O BROADWAY, SUITE 702, NEW YORK, NY, 10038, US

(21) Appl. No.: 11/481,646

(22) Filed: Jul. 6, 2006

(51) Int. Cl. H04Q 7/20

(52) U.S. Cl. 455/524; 370/338

(57) ABSTRACT

Described is a system and method for optimizing wireless client communications. The system comprises a plurality of access points and a network management arrangement. The access points conduct wireless communications on a radio frequency channel with a plurality of wireless computing units. The access points are associated with a common destination identifier. The network management arrangement generates a list for each of the access points. The list includes source identifiers for selected ones of the wireless computing units. One of the access points only transmits a response signal in response to a received signal that includes a received signal source identifier matching one of the source identifiers on the list of the one access point.

### FIELD OF THE INVENTION

The present invention generally relates to a system and method for optimized wireless client communication.

### BACKGROUND

A conventional wireless network includes one or more access points (“APs”) allowing a user of a mobile unit (“MU”) to move freely within the network while maintaining a connection thereto. As the MU moves within the network, it may cease communicating with a first AP and begin communicating with a second AP, which is commonly referred to as a “roam.” To initiate communication with the second AP, the MU re-executes a roam procedure which was previously executed with the first AP. The roam procedure includes association and authentication of the MU by the second AP, and typically requires approximately 200 milliseconds to 3 seconds to complete. Thus, roaming between APs may cause a delay in the MU's communication on the network. For latency-sensitive applications (e.g., Voice over Internet Protocol (“VoIP”) calls), the delay may result in a termination of the connection of the MU to the network.

### SUMMARY OF THE INVENTION

The present invention generally relates to a system and method for optimized wireless client communication. The system comprises a plurality of access points and a network management arrangement. The access points conduct wireless communications on a radio frequency channel with a plurality of wireless computing units. The access points are associated with a common destination identifier. The network management arrangement generates a list for each of the access points. The list includes source identifiers for selected ones of the wireless computing units. One of the access points only transmits a response signal in response to a received signal that includes a received signal source identifier matching one of the source identifiers on the list of the one access point.

### BRIEF DESCRIPTION OF THE DRAWINGS

FIG. 1 shows an exemplary embodiment of a system according to the present invention;

FIG. 2 shows an exemplary embodiment of a method according to the present invention; and

FIG. 3 shows an exemplary embodiment of another method according to the present invention.

### DETAILED DESCRIPTION

The present invention may be further understood with reference to the following description and the appended drawings, wherein like elements are referred to with the same reference numerals. The present invention describes a system and a method for optimized wireless client communication. In the exemplary embodiment, the system includes multiple access points (“APs”) which are configured to utilize one basic service set identifier (“BSSid”) simulating a single AP. Thus, a mobile unit (“MU”) may travel about the WLAN and maintain a seamless wireless connection to a wireless network without suffering a delay associated with roaming. Although the exemplary embodiments of the present invention are described with reference to an IEEE 802.11 wireless network, those of skill in the art will understand that the present invention may be implemented in other types of network protocols and architectures.

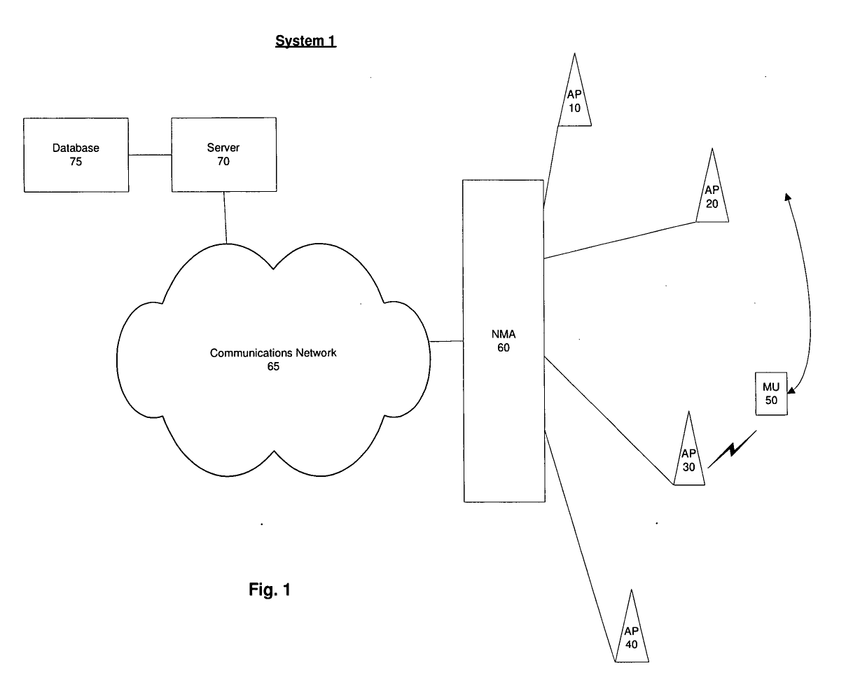

FIG. 1 shows an exemplary embodiment of a system 1 according to the present invention. The system 1 includes a network management arrangement (“NMA”) 60, which is wired/wirelessly coupled to at least one AP (e.g., APs 10, 20, 30, and 40). The system 1 may further comprise a server 70 and a database 75 coupled to the NMA 60 over a communications network 65. The NMA 60 may be a switch, router, hub, etc.

Each of the APs 10-40 has a corresponding coverage area which defines a range over which the AP may transmit and receive radio frequency (“RF”) signals. A mobile unit (“MU”) 50 located within a particular coverage area may communicate with a corresponding AP. The MU 50 may be one of a laser-/imager-based scanner, an RFID reader, a mobile phone, a PDA, a tablet computer, a network interface card, a laptop, a digital camera and a portable media player. The MU 50 may be located in the coverage area of the AP 30 and communicate therewith. The APs 10-40 may either be single channel APs (e.g., 2.4 GHz or 5.1 GHz) or multiple channel APs (e.g., 2.4 GHz and 5.1 GHz). Multiple channel APs may potentially support a first channel of single BSS operation, according to the present invention, concurrently with a second channel of single BSS operation or conventional AP operation.

In a conventional 802.11 network, each AP has a unique BSSid. Thus, if a packet is addressed to and received by an AP (e.g., AP 30), the AP 30 will accept the packet and transmit an acknowledgment to the source device (e.g., the MU 50). If the packet is not addressed to BSSid for the AP 30, it is ignored. According to the present invention, every AP (e.g., APs 10-40) or selected ones of the APs 10-40 have the same BSSid. Thus, the MU 50 assumes it is only communicating with a single AP. The system 1 may handle a plurality of MUs at any time, wherein each MU addresses packets to the same BSSid.

In the exemplary embodiment, the NMA 60 monitors operation and performance parameters of the APs and the MUs. The NMA 60 supplies each AP with a list of MUs with which it should communicate. For example, due to a predetermined set of parameters (e.g., RSSI, TDOA, location load, communication type, etc.), the NMA 60 may include the MU 50 on the list supplied to the AP 30. Thus, for each packet received by the AP 30, a source address is compared against the list. If the source address is contained in the list, the AP 30 acknowledges the packet; otherwise the packet may be ignored. The NMA 60 analyzes the set of parameters to update the list for each AP, e.g., moving the address for MU 50 to another AP.

In addition, the APs 10-40 may be synchronized so that they each transmit beacons at substantially the same time. In the exemplary embodiment, one AP is selected by the NMA 60 to serve as a timing master AP. The timing master AP is preferably an AP in a geographically central location relative to the other APs. The timing master AP may set the timing for its beacon, and the remaining APs set their local timing synchronization function (“TSF”) timers to the beacon transmitted by the timing master AP. If any APs cannot hear the beacon transmitted by the timing master AP, a first set of the remaining APs (e.g., “Primary APs”) may also be configured to transmit beacons to the other remaining APs (e.g., “Secondary APs”). The Primary APs synchronize their local TSFs to the beacon from the timing master AP. The Secondary APs may suspend transmissions to avoid interfering with the beacon transmission by the timing master AP and the Primary APs.

In the exemplary system, other tasks commonly performed in conventional IEEE 802.11 protocols may be altered. For example, in conventional wireless networks, all APs periodically transmit beacons, thereby informing MUs of their presence. However, in the single BSS system, simultaneous transmissions from the APs may collide and consume too much bandwidth. These problems may be overcome by classification of the APs 10-40 into Primary APs and Secondary APs, as described above. To prevent collisions and reduce bandwidth consumption, the Primary APs may transmit their beacons at a predetermined offset from one another so as to allow a distributed coordination function (“DCF”) to occur and minimize collisions. The offset is preferably small enough to avoid disrupting normal network operation, but large enough to avoid collisions. The offsets may be fixed by the NMA 60, or they may be randomly determined by the Primary APs on a per packet basis. A TSF value in each beacon frame may be adjusted to reflect the offset.

The MU 50 initiates communication with the network 65 by transmitting an association request to an AP whose beacon it has heard. The AP 30 forwards the association request to the NMA 60, which will either grant or deny it. If more than one AP receives and forwards the association request, the NMA 60 selects the AP which will grant the association request. If the NMA 60 grants the association request, the MU 50 is authenticated and begins communication on the network 65. Thus, the NMA 60 may control communications between the MU 50 and the APs 10-40.

In a conventional IEEE 802.11 wireless network, the MU 50 must reassociate and reauthenticate each time it attempts to communicate with a new AP (e.g., when the MU 50 migrates into a different coverage area, determines that the new AP is better suited to handle the MU 50, etc.). Repetition of the association and authentication procedures delays access to the network 65 for the MU 50.

According to the present invention, the MU 50 may communicate with each AP 10-40 without having to re-execute the association/authentication process. After the MU 50 initially associates/authenticates with an AP, the NMA 60 may transfer responsibility for the MU 50 to/from each AP.

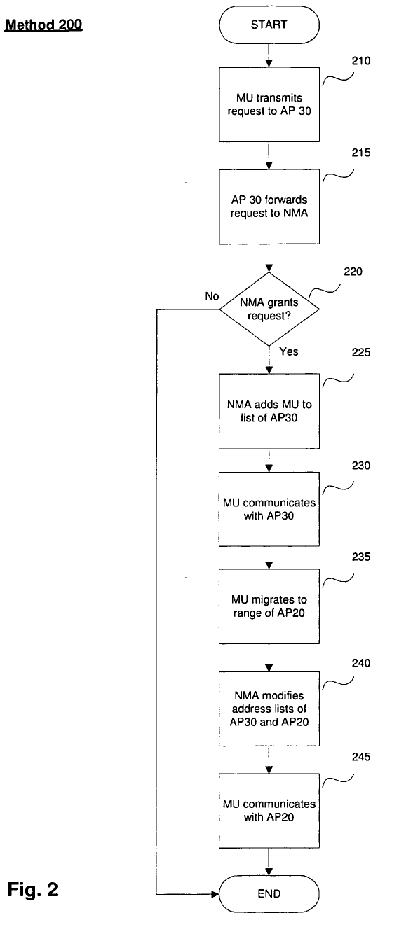

FIG. 2 shows an exemplary method 200 for roamless client-side communication according to an embodiment of the present invention. The method 200 will be described with reference to the system 1 of FIG. 1. However, it will be understood by those of skill in the art that the method 200 may be implemented in various network architectures.

In step 210, the MU 50 transmits an association request to the AP 30, because the MU 50 hears a beacon therefrom and determines that the AP 30 will provide the best connection to the network 65. In step 215, the AP 30 forwards the request to the NMA 60. The NMA 60 may then grant the request (step 220). It will be understood by those of skill in the art that the NMA 60 may alternatively deny the request, depending on a number of factors (e.g., identifying information of the MU 50, encryption information, current network load, unauthorized MU, etc.). However, for purposes of the present example, it is assumed that the NMA 60 grants the request. The NMA 60 may then notify the AP 30 of its grant of the request.

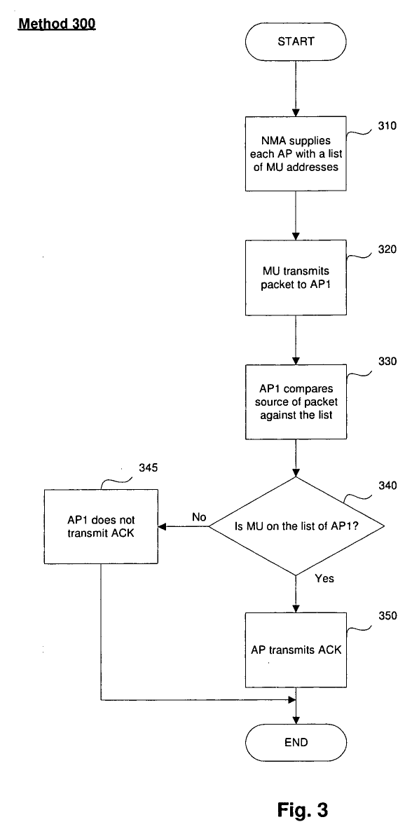

In step 225, the NMA 60 adds the MU 50 to the list of MUs supported by the AP 30. The list identifies all MUs which communicate with the AP 30. The MU 50 may then communicate with the AP 30 (step 230). That is, the AP 30 will acknowledge packets transmitted by the MU 50. This will be described in more detail with respect to FIG. 3.

In step 235, the MU 50 migrates to a coverage area of another AP (e.g., the AP 20). The MU 50 continues to transmit packets (e.g., data packets, voice packets, etc.) and the APs that can hear the MU 50 may forward some or all of the packets to the NMA 60. Because the packets may contain location information (e.g., received signal strength indication (“RSSI”) values) pertaining to the MU 50, the NMA 60 may determine a location of the MU 50 relative to the APs 10-40. Thus, the NMA 60 may recognize when the MU 50 migrates to another coverage area, e.g., from the coverage area of the AP 30 to the coverage area of the AP 20.

In step 240, the NMA 60 modifies the lists of the APs 20 and 30 by, for example, deleting the MU 50 from the list of the AP 30, and adding the MU 50 to the list of the AP 20. Thus, the AP 20 responds to packets from the MU 50, and the AP 30 does not. Accordingly, the MU 50 communicates with the AP 20 (step 245). This procedure may be repeated each time the MU 50 travels to another coverage area or at any other rime determined by the NMA 60, thereby permitting roamless client-side communication.

In the method 200 described above, communication with another AP (i.e., the AP 20) was initiated by migration of the MU 50 into the coverage area of the AP 20 in step 235. However, it should be understood that communication with another AP may be initiated in a variety of other circumstances. For example, in another embodiment of the invention, the NMA 60 may transfer responsibility for the MU 50 to another AP based on RSSI values, throughput, load, etc., which may be indicated in packets forwarded from the AP(s) to the NMA 60. That is, the NMA 60 may receive packets from the APs 20 and 30 regarding the MU 50, because the MU 50 is in the coverage areas of both the AP 20 and the AP 30.

FIG. 3 shows an exemplary method 300 for authorizing communication between an AP and an MU. The method 300 will be described with reference to the system 1 of FIG. 1. However, it will be understood by those of skill in the art that any of a variety of network protocols and architectures may be used. In this example, it is to be assumed that the MU 50 has already associated and authenticated with the network 65 through one or more APs 10-40.

In step 310, the NMA 60 supplies each AP 10-40 with a list of MU addresses. The lists may be modified by the NMA 60 as a function of changes in the wireless network (e.g., MUs move, new APs are added etc.). However, as will be discussed below, each AP only acknowledges transmissions from the MUs that are included on its list.

In step 320, the MU 50 transmits a packet (e.g., a voice packet, a data packet, etc.) to the AP 20. Because the packet includes the BSSid used by the APs 10-40, each AP compares its list against the source address of the packet (step 330). For example, the AP 20 searches its list for information such as a medium access control (“MAC”) address, IP address, serial number, etc. which identifies the MU 50. Accordingly, in step 340, the AP 20 determines whether the MU 50 is on its list, and thus whether it should acknowledge the packet transmitted by the MU 50.

As discussed above with respect to the method 200, the presence of the MU 50 on a particular AP's list may be controlled by the NMA 60. However, according to an alternative embodiment, the APs 10-40 may be smart APs, thereby enabled to share lists. For example, as the MU 50 migrates from the coverage area of the AP 30 to that of the AP 20, the AP 30 may transmit information (e.g., a copy of its list, the entry for the MU 50 on the list, etc.) to the AP 20. If the AP 20 in step 340 determines that the MU 50 is on its list, the AP 20 transmits an acknowledgment (“ACK”) to the MU 50 (step 350). Thereafter, the MU 50 communicates with the network 65 through the AP 20. However, if the AP 20 determines that the MU 50 is not on the list, the AP 20 will ignore the packet. However, because the NMA 60 recognizes that the MU 50 has transmitted the packet, it may add the MU 50 to the list of another AP (e.g., the AP 30) to provide the MU 50 with a connection to the network 65.

The method 300 may be optimized in order to reduce a burden on the APs when screening a packet to determine if it was transmitted by an MU on its list. For example, a simple 32 to 128 byte bit map may be indexed using a lower 8 to 10 bits of the source address. Thus, if an addressed bit is 0, the packet is ignored by the AP. If the addressed bit is a 1, then the AP may accept the packet and perform further address searches. As such, a substantial amount of packets transmitted by the MUs not supported by the AP may be filtered out with few instructions. The method 300 may further be optimized by dividing the accepted packets into various hash buckets based upon some number of bits on the source address. Accordingly, packets which passed through the first filtration may be filtered out with merely a few more instructions.

Transmission of broadcast and multicast packets in the single BSS system may be handled similarly to the beacons. For example, the broadcast/multicast packets may be sent by the NMA 60 to the Primary APs. The Primary APs may transmit the broadcast/multicast packets either immediately upon receipt, or after a delivery traffic indication message (“DTIM”). The broadcast/multicast packets may be transmitted at random delays, thereby minimizing a potential for collisions.

The single BSS system may also vary from conventional protocols with respect to transmission of probe requests and responses. Particularly, the APs may be configured to ignore probe requests from the MU 50 which are below a specified RSSI threshold. Therefore, a potential conflict of multiple APs attempting to service the MU 50 is decreased. Further, if a first AP hears a response generated by another AP, the first AP may terminate transmission of its probe response. Copies of probe requests may be forwarded by the APs 10-40 to the NMA 60, thereby enabling the NMA 60 to monitor signal strengths of the MU 50 relative to the APs 10-40.

According to the exemplary embodiment, clear to send (“CTS”) packets may be transmitted by the Primary APs. However, all APs will respect a time interval specified by a request to send (“RTS”) packet.

The exemplary embodiment may also vary from a conventional system with respect to handling of poll and null packets. Also according to the exemplary embodiment, poll/null packets may be acknowledged by the AP that supports the MU 50. After the MU 50 transmits the packet, all APs that receive it forward it to the NMA 60. The poll/null packets may include location information (e.g., RSSI value) relating to the MU 50, and thus the APs may be configured to forward the packet only if the RSSI is above a predetermined threshold. Upon receiving the packets from the APs, the NMA 60 may select an optimal AP to support the MU 50, thereby deciding to “roam” based on updated information. Accordingly, even if the MU 50 is disabled (e.g., in power save mode, turned off, etc.) as it migrates out of range of the AP 30, the NMA 60 may determine that another AP is better suited to support the MU 50.

As discussed above, data packets are handled by the AP which supports the MU 50. According to the exemplary embodiment, other APs, which are not supporting the MU 50, may additionally forward a predetermined percentage of data packets (i.e., “sample packets”) for the MU 50 to the NMA 60. These sample packets provide the NMA 60 with additional signal strength information.

Embodiments of the present invention may also vary from a conventional system with respect to wireless multimedia (“WMM”) scheduling. Many of the WMM scheduling algorithms in conventional systems use beacon transmission time as a basis for controlling access to a channel. According to the exemplary embodiment, a similar WMM scheduling algorithm may be used, despite generation of beacons by only the Primary APs. Because the Secondary APs monitor and synchronize with the beacons transmitted by the Primary APs, they may recognize an appropriate time to transmit packets to their MUs.

As mentioned above, in the exemplary embodiment “roaming” is performed by the NMA 60, as opposed to a conventional system wherein it is performed by the MUs. That is, the NMA 60 transfers responsibility for the MU from one AP to another. An algorithm used by the NMA 60 to determine when to perform a roam procedure may be based on a combination of factors. For example, the algorithm may be based on RSSI values, data rates, retry counts, etc. The NMA 60 may receive a significant amount of data corresponding to each MU, because all APs may potentially forward copies of probe requests, copies of association packets, and the sample data packets. However, the roaming algorithm may be tailored to use only the data that it most pertinent to the NMA's decision.

The present invention may be efficient in saving costs related to reassociation and reauthentication. Specifically, a user will not experience a delay and/or a terminated communication (e.g., a “dropped call”) because the MU 50 is roaming in another coverage area. Thus, the MU 50 maintains a seamless connection to the network 65.

Another advantage of the present invention is that it can be implemented with only minor changes to a wireless switch protocol (“WiSP”). The minor changes may include addition of certain configuration options to the protocol. For example, configuration options for various procedures (e.g, specifying operation in Single BSS mode, specifying whether an AP is a Primary or Secondary, adding and/or removing MU addresses, and specifying a percentage of data packets to be “leaked” to the switch, etc.) may be added. The minor changes may also include indicating to the NMA 60 which packets are for NMA roaming usage.

The present invention may also be implemented without any client side upgrades.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a plurality of access points conducting wireless communications on a radio frequency channel with a plurality of wireless computing units, the access points being associated with a common destination identifier; and
a network management arrangement generating a list for each of the access points, the list including source identifiers for selected ones of the wireless computing units,
wherein, one of the access points only transmits a response signal in response to a received signal that includes a received signal source identifier matching one of the source identifiers on the list of the one access point.

2. The system according to claim 1, wherein the wireless computing units include at least one of a laser-based scanner, an imager-based scanner, an RFID reader, a mobile phone, a PDA, a network interface card, a laptop, a digital camera, a portable media device and a handheld computer.

3. The system according to claim 1, wherein the common destination identifier is a basic service set identifier (BSSid).

4. The system according to claim 1, wherein the source identifier is one of a media access control address, an internet protocol address and a serial number.

5. The system according to claim 1, wherein the network management arrangement is one of a switch, a hub and a router.

6. The system according to claim 1, wherein the network management arrangement generates the list as a function of at least one of (i) locations of the selected wireless computing units, (ii) a load on the access points, (iii) a received signal strength indicator value of the received signal, (iv) a retransmission rate and (v) a cell capacity.

7. The system according to claim 1, wherein the one access point filters a plurality of received signals to determine when to generate the response signal.

8. The system according to claim 7, wherein the one access point uses one of (i) a 32 to 128 byte bit map indexed using a lower 8 to 10 bits of the received signal source identifier and (ii) a hash bucket based upon a predetermined number of bits in the received signal source identifier to filter the plurality of received signals.

9. The system according to claim 1, wherein the plurality of access points include a timing master access point and primary access points, wherein the primary access points transmit beacons as a function of a timing synchronization function indicated in a master beacon transmitted by the timing master access point.

10. The system according to claim 9, wherein the network management arrangement selects the timing master access point from the plurality of access points as a function of a geographical location of the timing master access point relative to geographical locations of each of the plurality of access points.

11. The system according to claim 10, wherein the beacons transmitted by the primary access points are transmitted at an offsets from each other.

12. The system according to claim 1, wherein the list further includes at least one of authentication data and encryption data for the selected wireless computing units.

13. A method, comprising:
receiving a wireless signal by an access point, the signal including a common destination identifier to the access point and at least one further access point;
detecting a source identifier of the signal, the source identifier identifying a wireless computing unit which transmitted the signal; and
when the source identifier matches an entry on a list of source identifiers stored by the access point, transmitting a response signal to the wireless computing unit.

14. The method according to claim 13, further comprising:
downloading the list from a network management arrangement.

15. The method according to claim 13, wherein the destination identifier is a basic service set identifier.

16. The method according to claim 13, wherein the source identifier is one of a media access control address, an internet protocol address and a serial number.

17. The method according to claim 13, wherein the list further includes authentication data for the wireless computing unit.

18. A method, comprising:
monitoring characteristics of wireless communications between a plurality of access points and a plurality of wireless computing units, each of the access points utilizing a common destination identifier in communications with the wireless computing units; and
generating a list for each of the plurality of access points as a function of the characteristics, the list including source identifiers identifying selected ones of the wireless computing units so that when a wireless signal is received by a corresponding access point using the list, the corresponding access point transmits a response signal to a corresponding one of the wireless computing units which transmitted the wireless signal.

19. The method according to claim 18, further comprising:
downloading the list to the corresponding access point.

20. The method according to claim 18, wherein the characteristics include at least one of (i) a location of each of the wireless computing units, (ii) a load on each of the access points, (iii) a received signal strength indicator value of the wireless signal, (iv) a retransmission rate and (v) a cell capacity.

21. A device, comprising:
a storage means for storing characteristics of wireless communications between a plurality of access points and a plurality of wireless computing units, each of the access points utilizing a common destination identifier in communications with the wireless computing units; and
a processing means for generating a list for each of the plurality of access points as a function of the characteristics, the list including source identifiers identifying selected ones of the wireless computing units so that when a wireless signal is received by a corresponding access point using the list, the corresponding access point transmits a response signal to a corresponding one of the wireless computing units which transmitted the wireless signal.
